(19) United States
(12) Patent Application Publication
(10) Pub. No.: US 2008/0313216 A1
(43) Pub. Date: Dec. 18, 2008

(54) FILE MANAGEMENT APPARATUS AND FILE TRANSFER METHOD AND IMAGING APPARATUS

(76) Inventor: Hisakazu KOBAYASHI, Hyogo (JP)

Correspondence Address: WENDEROTH, LIND & PONACK L.L.P., 2033 K. STREET, NW, SUITE 800, WASHINGTON, DC, 20006, US

(21) Appl. No.: 12/139,600

(22) Filed: Jun. 16, 2008

(30) Foreign Application Priority Data
Jun. 14, 2007 (JP) 2007-157235

(51) Int. Cl. G06F 17/30

(52) U.S. Cl. 707/102; 707/E17.019

(57) ABSTRACT

A file management apparatus for transferring a data file stored in a first recording medium (ex. embedded flash memory) to a second recording medium (ex. memory card), includes a controller that creates a new directory in the second recording medium, and stores to the new directory the data file stored in a predetermined directory of the first recording medium, if at least one of the data files stored in the predetermined directory in the first recording medium has the same file name as any one of the data files stored in the directory in the second recording medium having the same name as that of the predetermined directory. Otherwise, the controller stores the data file stored in the predetermined directory of the first recording medium, to the directory in the second recording medium having the same name as that of the predetermined directory.

### BACKGROUND ART

1. Field of the Invention

The present invention relates to an apparatus for managing transfer of data file among plural recording media, for example, data transfer between an embedded recording medium in an apparatus and a removable external recording medium.

2. Related Art

A digital still camera shoots an image of a subject, and records data of the shot image in a recording medium. Generally, a removable external memory such as a SD memory card (registered trademark) is used as a recording medium for storing shot image data. In recent years, a digital still camera provided with, as a medium for storing the shot image data, a built-in memory in addition to the removable external memory has been developed. For example, JP-A-02-292974 discloses an electronic still camera capable of reading and reproducing the image data from both of the built-in memory and the external memory as needed.

For the imaging apparatus using the built-in memory and the external memory as a medium for storing the shot image data, there may be an application for transferring image files between the built-in memory and the external memory. There may be sometimes image files having completely different contents of data but having the same file name in each of the built-in memory and the external memory.

In a case where there is image files having the same file name between the recording media as a transfer destination and a transfer source, when the image file is transferred (copied) without changing the file name at the time of transferring from one recording medium to the other recording medium, the image file of the same file name is overwritten on the transfer destination recording medium. At this time, when there is an image file having the same name but completely different contents of data between the transfer destination recording media and the transfer source recording media, there is a problem that a required image file may be unintentionally deleted.

In order to prevent such a problem, there is a method of creating a new directory in the transfer destination at the time of transfer, and storing the image file of the transfer source in the newly created directory. However, when such an operation is performed every time of the transfer, the number of directories in the transfer destination medium is increased by each transfer, thus involving a problem that the management of the image file on the transfer destination is complicated.

An object of the present invention is to provide the file management apparatus capable of preventing unintentional deletion of the data file on the transfer destination, suppressing unnecessary increase of the directories in the transfer destination medium, and preventing a complication of a file management.

### SUMMARY OF THE INVENTION

In a first aspect of the invention, a file management apparatus for transferring a data file stored in a first recording medium to a second recording medium is provided. The file management apparatus includes a receiving unit operable to receive a transfer command for transferring a data file stored in a predetermined directory in the first recording medium to the second recording medium, and a controller operable to control the transfer of the data file in accordance with the received command. When the receiving unit receives the transfer command, if at least one of the data files stored in the predetermined directory in the first recording medium has the same file name as any one of the data files stored in the directory in the second recording medium having the same name as that of the predetermined directory, the controller creates a new directory in the second recording medium, and stores (moves) to the new directory the data file stored in the predetermined directory of the first recording medium. If no one of the data files stored in the predetermined directory of the first recording medium has the same file name as those of data files stored in the directory in the second recording medium having the same name as that of the predetermined directory, the controller stores (moves) the data file stored in the predetermined directory of the first recording medium, to the directory in the second recording medium having the same name as that of the predetermined directory.

In a second aspect of the invention, an imaging apparatus having an imaging element for generating an image signal from optical information of a subject, capable of recording an image file generated based on the image signal to a first recording medium or a second recording medium is provided. The imaging apparatus includes a receiving unit operable to receive a transfer command for transferring a data file stored in a predetermined directory in the first recording medium to the second recording medium, and a controller operable to control the transfer of the data file in accordance with the received command. When the receiving unit receives the transfer command, if at least one of the data files stored in the predetermined directory in the first recording medium has the same file name as any one of the data files stored in the directory in the second recording medium having the same name as that of the predetermined directory, the controller creates a new directory in the second recording medium, and stores to the new directory the data file stored in the predetermined directory of the first recording medium. If no one of the data files stored in the predetermined directory of the first recording medium has the same file name as those of data files stored in the directory in the second recording medium having the same name as that of the predetermined directory, the controller stores the data file stored in the predetermined directory of the first recording medium, to the directory in the second recording medium having the same name as that of the predetermined directory.

In a third aspect of the invention, a file transfer method for transferring a data file stored in a first recording medium to a second recording medium is provided. According to the method,

a) It is determined if at least one of the data files stored in the predetermined directory in the first recording medium has the same file name as any one of the data files stored in the directory in the second recording medium having the same name as that of the predetermined directory.

b) When at least one of the data files stored in the predetermined directory in the first recording medium has the same file name as any one of the data files stored in the directory in the second recording medium having the same name as that of the predetermined directory, a new directory is created in the second recording medium, and the data file stored in the predetermined directory of the first recording medium is stored to the new directory.

c) When no one of the data files stored in the predetermined directory of the first recording medium has the same file name as those of data files stored in the directory in the second recording medium having the same name as that of the predetermined directory, the data file stored in the predetermined directory of the first recording medium is stored to the directory in the second recording medium having the same name as that of the predetermined directory.

According to the present invention, unintentional deletion of data files in the recording medium of the transfer destination can be prevented, and unnecessary increase of the directories in the recording medium of the transfer destination can be prevented, thus facilitating the management of the transferred data files.

### BRIEF DESCRIPTION OF DRAWINGS

FIG. 1 is a block diagram showing a structure of a digital camera according to an embodiment of the present invention.

FIG. 2 is a flowchart showing a recording operation of the digital camera according to the embodiment of the present invention.

FIGS. 3A and 3B are views each showing an example of a directory structure in a memory card.

FIGS. 4A and 4B are views each showing an example of the directory structure in a flush memory.

FIG. 5 is a flowchart showing a file transfer operation of the digital camera according to the embodiment of the present invention.

FIG. 6A is a view showing an example of the directory structure in the memory card as transfer destination before transferring image files, and FIG. 6B is a view showing an example of the directory structure in the flush memory as transfer source (example 1).

FIG. 7 is a schematic view showing an example of the directory structure in the memory card after transferring image files (example 1).

FIG. 8A is a view showing an example of the directory structure in the memory card as transfer destination before transferring image files, and FIG. 8B is a view showing an example of the directory structure in the flush memory as transfer source (example 2).

FIG. 9 is a schematic view showing an example of the directory structure in the memory card after transferring image files (example 2).

FIG. 10A is a view showing an example of the directory structure in the memory card as transfer destination before transferring image files, and FIG. 10B is a view showing an example of the directory structure in the flush memory as transfer source (example 3).

FIG. 11 is a schematic view showing an example of the directory structure in the memory card after transferring image files (example 3).

### DETAIL DESCRIPTION OF PREFERRED EMBODIMENT

With reference to the accompanying drawings, preferred embodiment of the present invention is described below.

### 1 Configuration

### 1.1 Configuration of Digital Camera

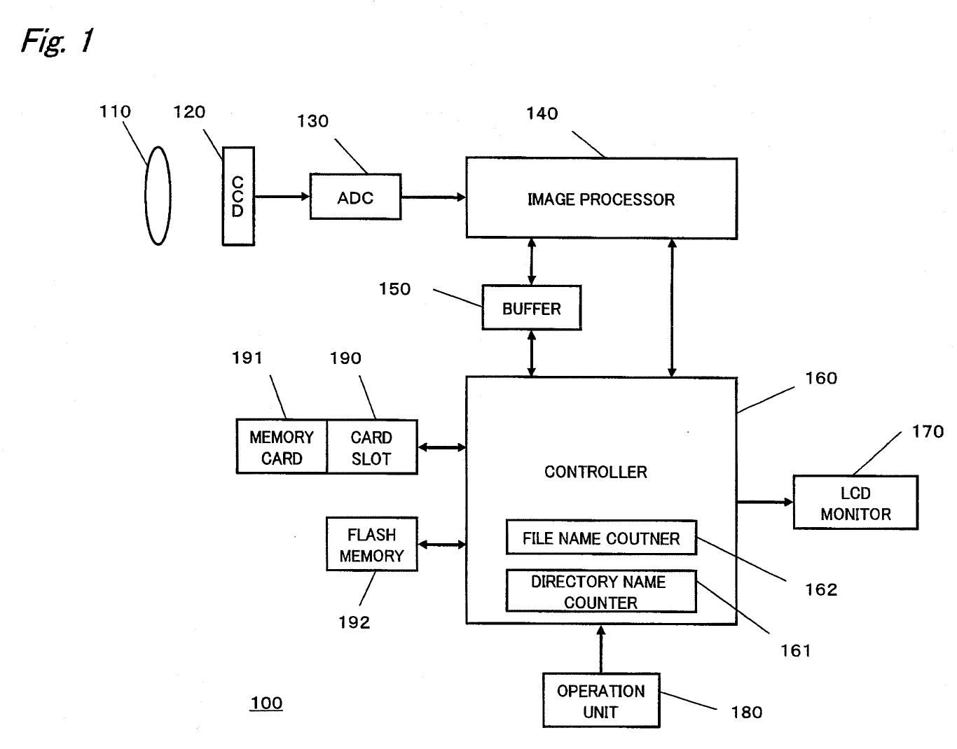

FIG. 1 is a block diagram showing a configuration of a digital camera 100 according to an embodiment of the present invention. An optical system 110 includes a lens, and so on, collects optical signals from a subject to form an image of the subject. A CCD image sensor 120 images the subject image based on the optical signals received via the optical system 110 to generate an image signal. An AD converter 130 digitizes the image signal generated by the CCD image sensor 120 to generate image data. An image processor 140 applies various image processing to the digitized image data. For example, the image processor 140 performs gamma correction processing, flaw correction processing, white balance correction processing, YC conversion processing, electron zoom processing, compression processing, and decompression processing, and so on. However, it is not necessary to perform all of them.

A controller 160 controls entirely the digital camera 100. The controller 160 includes a directory name counter 161 and a file name counter 162 inside. The controller 160 can recognize the present directory name or the next directory name by referring to the directory name counter 161, and can recognize the present file name or the next file name by referring to the file name counter 162. The directory name counter 161 and the file name counter 162 provide a part of characters used in the directory name and the file name. Details of a naming rule of the directory name and the file name will be described later.

A buffer 150 functions as a work memory of the image processor 140 and the controller 160. A liquid crystal display (LCD) monitor 170 can display an image based on the image data processed by the image processor 140. In addition, the LCD monitor 170 can display a screen image for various kinds of settings. An operation unit 180 transmits command information of a user to the controller 160 based on user's operation. The operation unit 180 includes, for example, a shutter button, direction buttons, and a set button.

A memory card 191 as a removable recording medium is inserted into a card slot 190. Data and command are received/transmitted between the digital camera 100 and the memory card 191 via the card slot 190. The card slot 190 may include a card controller for controlling the memory card 191. The memory card 191 can store image files in one or more directories.

A flush memory 192 is an embedded memory in the digital camera 100. The flush memory 192 can store image files in one or more directories.

When the memory card 191 is not inserted in the card slot 190, the controller 160 stores the shot image file in the flush memory 192. When the memory card 191 is inserted in the card slot 190, the controller 160 stores the shot image file to a recording medium (memory card 191 or the flush memory 192) which is selected by the user via the operation unit 180.

The operation unit 180 can receive an command for transfer of an image file stored in the flush memory 192 to the memory card 191 inserted in the card slot 190. In this case, the screen image displayed on the LCD monitor 170 may be manipulated with the operation unit 180 so that the operation unit 180 can receive the command for transfer of an image file stored in the flush memory 192 to the memory card 191 inserted to the card slot 190.

1.2 Correspondence between Embodiment and Present Invention

The digital camera 100 is an example of the file management apparatus of the present invention. The memory card 191 is an example of the removable external recording medium of the present invention. The CCD 120 is an example of the image shooting device of the present invention. The controller 150 is an example of the control unit of the present invention. The flush memory 192 is an example of an embedded recording medium (memory) of the present invention. The operation unit 180 or combination of the operation unit 180 and the screen image displayed by the LCD monitor 170 is an example of a receiving unit of the present invention.

### 2. Operation

An operation of the digital camera 100 having the structure as described above is explained below.

### 2.0 Naming Rule of Directory Name and File Name

First, explanation is made to the naming rule of the directory name and the file name automatically provided when recording the shot image in the digital camera 100 of the embodiment. The controller 160 provides a directory name and a file name compliant with a DCF (Design Rule for Camera File system) standard and further according to the following rule.

Specifically, the directory name is represented as “xxxPANA”, for example. “xxx” is three digit numbers (001 to 999), and is usually sequence number given by referring to the directory name counter 161. “xxx” included in the directory name is called “directory number”. The file name is represented as “Pxxxyyyy.JPG”. Here, “xxx” is the directory number of the directory which stores the file. “yyyy” is four digit numbers (0001 to 9999), and is usually the sequence number given by referring to the file name counter 162. Hereinafter, “xxxyyyy” included in the file name is called “file number”. Note that the naming rule of the directory name and the file name described here is just an example, and the directory name and the file name may be named in other rules.

### 2.1 Recording Operation

### 2.1.1 Flow of Recording Operation

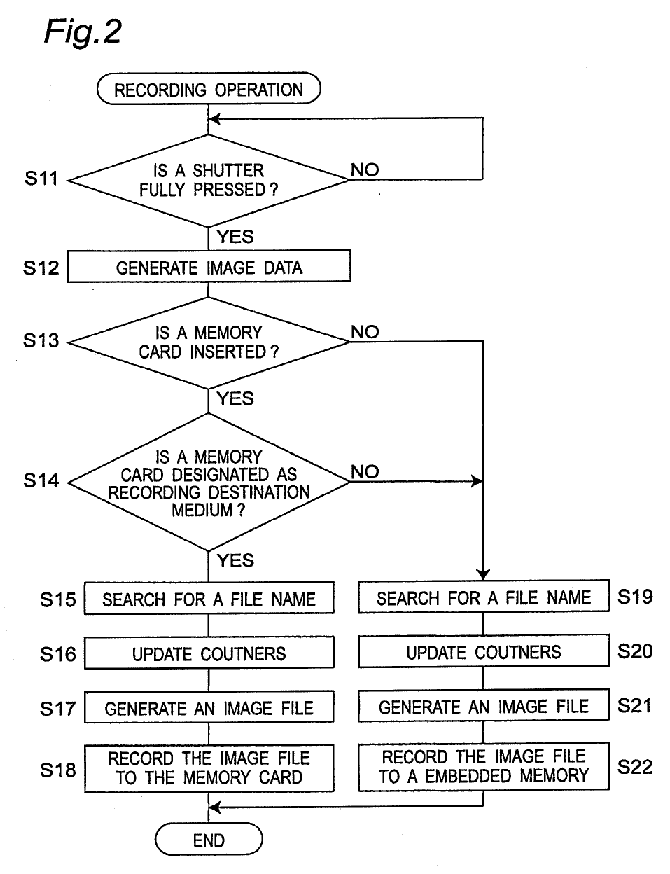

With reference to FIG. 2, a recording operation of the digital camera 100 is explained. FIG. 2 is a flowchart for explaining the recording operation of the digital camera 100. The controller 160 monitors whether or not the operation unit 180 receives a release instruction (S11). The release instruction is an instruction for shooting a picture which is made by a user fully pressing (totally depressing) the shutter button. When the operation unit 180 receives the release instruction, image data for recording is generated by the optical system 110, CCD image sensor 120, AD converter 130, image processor 140, and buffer 150 (S12).

Next, the controller 160 confirms whether or not the memory card 191 is inserted in the card slot 190 (S13). When the memory card 191 is inserted in the card slot 190, the controller 160 confirms whether the user designates, as a memory to store image files, the memory card 191 or the flush memory 192 (S14).

When the user designates the memory card 191 as a memory to store image files, the controller 160 searches for the file name to be provided next (S15). The search of the file name is specifically made as follows.

The controller 160 confirms whether or not a directory that can be created by itself exists in a recording area of the memory card 191, by referring to FAT. In the present embodiment, the controller 160 can create the directory name such as “xxxPANA”, and therefore it confirms whether or not a directory having a directory name of “PANA” exists in the memory card 191.

When the directory having the directory name of “PANA” does not exist in the memory card 191, the controller 160 newly creates a directory having a directory name of “PANA” in the memory card 191 in the following manner.

First, by referring to the file name counter 162, it is confirmed whether or not its counter value shows “9999”. When the counter value does not show “9999”, the directory name counter 161 is referenced, then a directory name is decided by using the value of the directory name counter 161, and a directory having the decided directory name is created in the memory card 191. Then, the file name counter 162 is incremented by one (S16). The file name of the image file to be newly stored in the memory card 191 is decided by using the value of the directory number of the generated directory added to the incremented counter value.

When the counter value of the file name counter 162 shows “9999”, the directory name counter 161 is incremented by one, and the value of the file name counter 162 is set to “0001” (S16). Then, the directory name is decided by using the counter value of the directory name counter 161, and a directory having the decided directory name is created. Further, the file name of the image file to be newly stored in the memory card 191 is decided by using the value of the directory number added to the counter value (“0001”) of the file name counter 162.

Meanwhile, when the directory having the directory name of “PANA” exists in the memory card 191, the controller 160 decides the file name of the image file as follows.

Namely, by referring to the FAT and the file name counter 162 in the memory card 191, the controller 160 searches for the file name having a largest file number (seven digit numerical value included in the file name) in the memory card 191 (S15). When the value of lower four digits of the file number is not “9999”, the controller 160 updates or counts up the file name counter 162 until the counter 162 shows the value of the lower four digits of the searched file number (S16) plus one. Next, the controller 160 refers to the FAT and the directory name counter 161 in the memory card 191, and searches for the directory name having the largest directory number (three digit numerical value included in the directory name). Then, the file name of the image file to be recorded is decided based on the searched directory number and the value shown by the file name counter 162.

Meanwhile, when the value of the lower 4 digits of the searched file number shows “9999” searched by the controller 160 by referring to the FAT and the file name counter 162 in the memory card 191, the value of the file name counter 162 is updated to “0001” (S16). Next, the controller 160 refers to the FAT and the directory name counter 161 in the memory card 191, and searches the directory name having the largest directory number. The controller 160 updates the directory name counter 161 so as to show the numerical value obtained by adding 1 to the searched directory number (S16). Finally, based on the numerical value shown by the directory name counter 161 and the numerical value shown by the file name counter 162, the file name of the image file is decided.

The image file is created with the image file name decided as described above (S17), and the image file thus created is stored in the memory card 191 (S18).

When it is decided that the memory card 191 is not inserted in the card slot 190 in step S13, or when the flush memory 192 is designated as a storage destination of the image file in step S14, the image file is stored in the flush memory 192. Specifically, the following processing is done.

First, the controller 160 searches for the file name to be provided next (S19). Specifically, the controller 160 confirms whether or not the directory that can be created by itself already exists in the recording area of the flush memory 192 by referring to the FAT. In this embodiment, the controller 160 can create the directory name such as “xxxPANA”, and therefore it confirms whether or not the directory having the directory name of “PANA” exists in the flush memory 192.

When no directory having the directory name of “PANA” exists in the flush memory 192, the controller 160 creates a directory having the directory name of “PANA” in the flush memory 192 as follows.

First, it is conformed whether or not the value shows “9999” by referring to the file name counter 162. When the value is not “9999”, by referring to the directory name counter 161, a directory having the numerical value shown by the directory name counter 161 as the directory number is created in the flush memory 192. Then, the file name counter 162 is incremented by one (S20), and the file name of the image file to be newly stored in the flush memory 192 is decided based on the value of the file name counter 162 to which the directory number is added. Meanwhile, when the value of the file name counter 162 is “9999”, the directory name counter 161 is incremented by one, and the value of the file name counter 162 is set to “0001” (S20). Then, the directory is created, with the value shown by the directory name counter 161 set as the directory number. Thereafter, the file name of the image file to be newly stored in the flush memory 192 is decided based on the directory number and the value (“0001”) of the file name counter 162.

Meanwhile, when the directory having the directory name of “PANA” exists in the flush memory 192, the controller 160 decides the file name of the image file as follows.

Specifically, the controller 160 refers to the FAT and the file name counter 162 in the flush memory 192, and searches for the file name having the largest file number (S19). When the value of the lower four digits of the searched file number is not “9999”, the controller 160 updates the file name counter 162 until it shows the value of the lower four digits of the searched file number plus one (S20). Next, the controller 160 refers to the FAT and the directory name counter 161 in the flush memory 192, and searches for the directory name having the largest directory number. Finally, the file name of the image file is decided based on the searched directory number and the value shown by the file name counter 162. Meanwhile, when the value of the lower four digits of the file number searched by the controller 160 is “9999”, the controller 160 updates the value of the file name counter 162 to “0001” (S20). Next, the controller 160 refers to the FAT and the directory name counter 161 in the flush memory 192, and searches for the directory name having the largest directory number. The controller 160 updates the directory name counter 161 so as to show the value of the searched directory number plus one. Finally, the file name of the image is decided based on the value shown by the directory name counter 161 and the value shown by the file name counter 162.

The image file is created by using the image file name decided as described above (S21), and is stored in the flush memory 192 (S22).

### 2.1.2 Example of Recording Operation

The recording operation of the aforementioned image file is explained below, with a specific example. Explanation is given for a case in which the memory card 191 is inserted in the card slot 190, the memory card 191 is designated as a medium for recording the shot image file, the directory for storing the image file is not created in the memory card 191, and the value of the directory name counter 161 is “100”, and the value of the file name counter 162 is “0000”.

After the image data to be recorded is generated (S12), the controller 160 confirms that the memory card 191 is inserted to the card slot 190 (S13), and confirms that the memory card 191 is designated as the recording medium of the shot image file (S14).

Since there is no directory for storing the image file in the memory card 191, the controller 160 refers to the directory name counter 161, and sets the directory name as “100PANA”. Here, the file name counter 162 shows “0000”. However, the value of the file name counter 162 may be the value other than “0000” in some cases where the digital camera 100 has created the image file for recording.

The controller 160 increments the file name counter 162 by one (S16). Then, the controller 160 decides the file name of the image file as “P1000001.JPG” based on the value shown by the directory name counter 161 and the value shown by the file name counter 162.

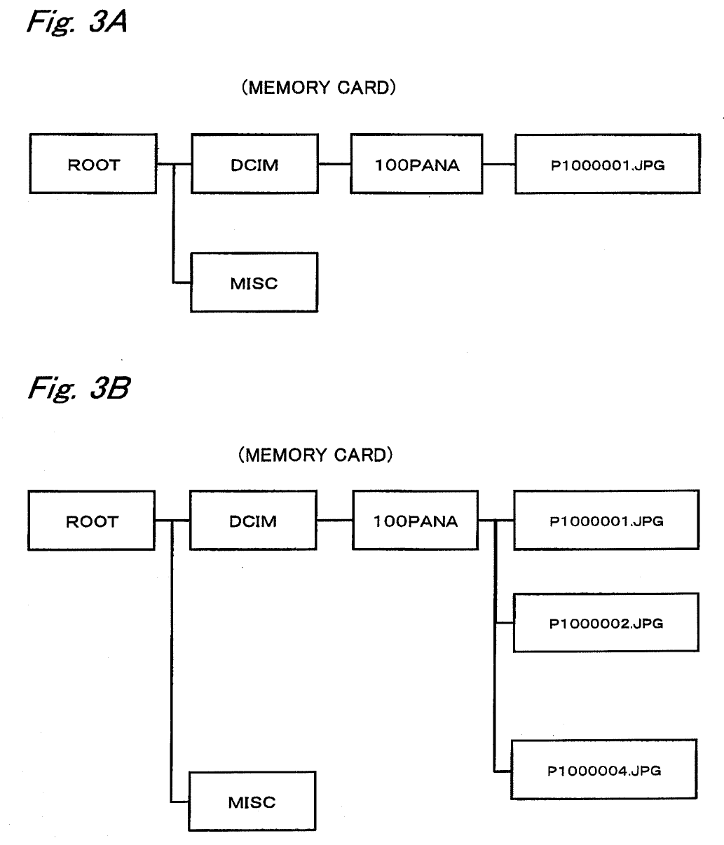

FIG. 3A shows an example of the directory structure in the memory card 191. “DCIM” directory is provided under “ROOT” directory. The “DCIM” directory is the directory compliant with the DCF standard, and is provided for storing image files. However, the data other than the image file can be stored in the “DCIM” directory.

As described above, as shown in FIG. 3A, the controller 160 creates “100PANA” directory under the “DCIM” directory, and creates the image file “P1000001.JPG” under “100PANA” directory. At this time, the directory name counter 161 shows “100”, and the file name counter 162 shows “0001”. In addition, the directory name “100PANA” and the image file name “P1000001.JPT” are registered in the FAT of the memory card 191.

Thereafter, when the second image data is created (S12), the controller 160 refers to the FAT in the memory card 191, the directory name counter 161, and the file name counter 162 (S15), and updates the file name counter 162 to “0002” (S16), and decides “P1000002.JPG” as the file name of the second image file.

Similarly, when the third and fourth image data is created, the controller 160 stores “P1000001.JPG” to “P1000004.JPG” in the memory card 191. At this time, the directory name counter 161 shows “100”, and the file name counter 162 shows “0004”. In addition, the directory name “100PANA” and the image file name “P1000001.JPG” to “P1000004.JPG” are registered in the FAT of the memory card 191.

However, the controller 160 can delete the image files in the memory card 191. Here, when the third image data “P1000003.JPG” is deleted by the operation of the user, as shown in FIG. 3B, “P1000001.JPG”, “P1000002.JPG”, and “P1000004.JPG” are stored in the memory card 191. Here, the deleting operation does not update the directory name counter 161 and the file name counter 162. Therefore the directory name counter 161 shows “100”, and the file name counter 162 shows “0004”. However, record of the image file name “P1000003.JPG” is erased in the FAT of the memory card 191.

Thereafter, it is assumed that the storage destination of the image file is switched to the flush memory 192 from the memory card 191 by the operation of the user. Also it is assumed that no image file has been stored in the flush memory 192, and the directory for storing the image file is not created in the flush memory 192.

When the fifth image data is created, the controller 160 refers to the value (“100”) of the directory name counter 161 and sets the directory name as “100PANA”, because there is no directory for storing the image file in the flush memory 192. Here, the file name counter 162 has been already updated four times, and therefore it shows “0004”.

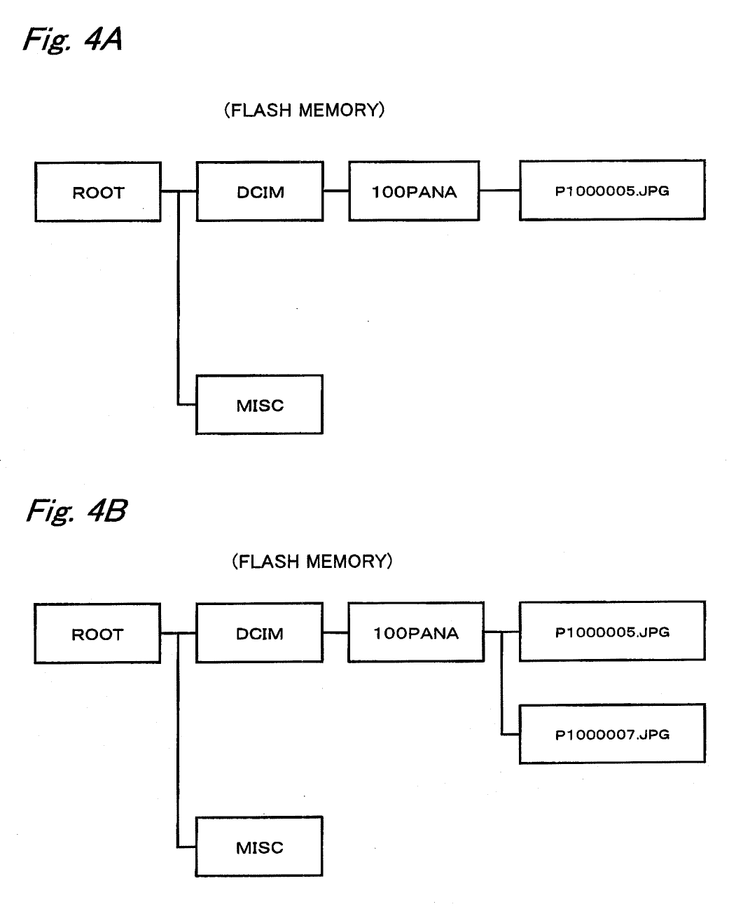

The controller 160 increments the file name counter 162 by one (S16), resulting in the counter value of “0005”. Then, the controller 160 decides “P1000005.JPG” as the file name of the image file from the value shown by the directory name counter 161 and the value shown by the file name counter 162, and stores the fifth image file in the flush memory 192 (S22). This state is shown in FIG. 4A.

Similarly, when the sixth and seventh image data to be recorded is generated, the controller 160 stores “P1000005.JPG” to “P1000007.JPG” in the flush memory 192. At this time, the directory name counter 161 shows “100”, and the file name counter 162 shows “0007”.

Further, also in the flush memory 192, the image file can be deleted by the operation of the user. Here, when the sixth image file is assumed to be deleted, only “P1000005.JPG” and “P1000007.JPG” are stored in the flush memory 192 as shown in FIG. 4B.

As described above, even when the storage destination of the image file is switched between the memory card 191 and the flush memory 192, the file name (particularly the file number portion) is decided as serial numbers, and therefore there is no case that the same image file name exists simultaneously in the memory card 191 and the flush memory 192. However, when the memory card 191 is switched and the other memory card is inserted in the card slot 190, there may be a case where the same image file name exists simultaneously in the memory card 191 and the other memory card. This is described in detail later.

### 2.2 Transfer Operation

### 2.2.1 Flow of Transfer Operation

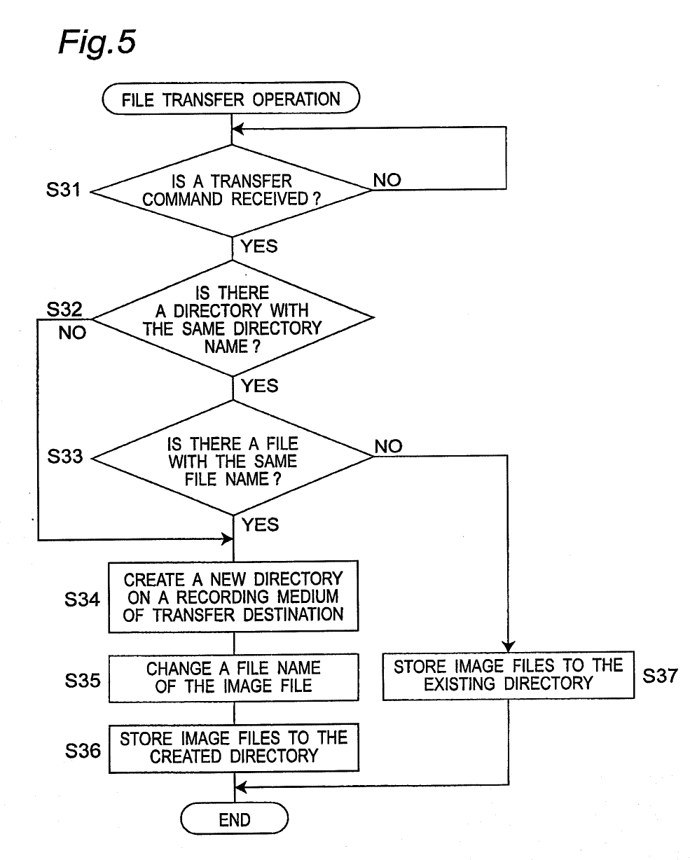

Next, with reference to the flowchart of FIG. 5, transfer operation of the image file from the flush memory 192 to the memory card 191 is explained.

The controller 160 monitors whether or not the operation unit 180 receives the command for transfer of the image file to the memory card 191 from the flush memory 192 (S31). When the operation unit 180 receives the transfer command, the controller 160 confirms whether or not an image file having the same file name exists double in the directory of the same directory name between the memory card 191 and the flush memory 192 (S32, S33). More specifically, the controller 160 confirms whether or not the same file name is provided to any one of the image files stored in the directory having the same name in the flush memory 192 and any one of the image files stored in the directory having the same name in the memory card 191.

When the same file name is provided to any one of the image files stored in the directory having the same name in the flush memory 192 and any one of the image files stored in the directory having the same name in the memory card 191 (Yes in S32, and Yes in S33), the controller 160 creates a new directory in the recording area of the memory card 191 (S34). Specifically, the controller 160 sets the value of the directory name counter 161 plus one as the directory number, and creates the directory of the directory name including the set directory number.

Then, a new image file name is obtained by adding the lower four digits of the file number of the file name of the image file of the transfer source, to the directory number (S35). Thereafter, the image file stored in the directory having the same name in the flush memory 192 is stored in the newly created directory by using the new image file (S36).

Thus, even when the image file of the same name is included in the image files stored in the memory card 191 of the transfer destination and the image files stored in the flush memory 192 of the transfer source, both of them can be stored in the memory card 191.

Meanwhile, when no same file name is provided to any of the image files stored in the directory having the same name in the flush memory 192 and any of the image files stored in the directory having the same name in the memory card 191 (Yes in S32, and No in S33), the image file stored in the directory having the same name in the flush memory 192 is stored in the directory having the same name in the memory card 191 (S37). Thus, the image file can be transferred to the memory card 191 from the flush memory 192 in such a manner that the number of directories is not increased as much as possible.

When there is no directory in the memory card 191 whose name is identical to the name of the directory of the flush memory 192 (No in S32), a directory is newly created in the memory card 191 in accordance with the value of the incremented directory name counter 161 (S34). A new image file name is set by adding the lower four digits of the file number of the file name of an original image file, to the directory number of the directory created (S35). Thereafter, the image file stored in the directory having the same name in the flush memory 192 is stored in the newly created directory by using the new image file name (S36).

### 2.2.2 Example 1 of Transfer Operation

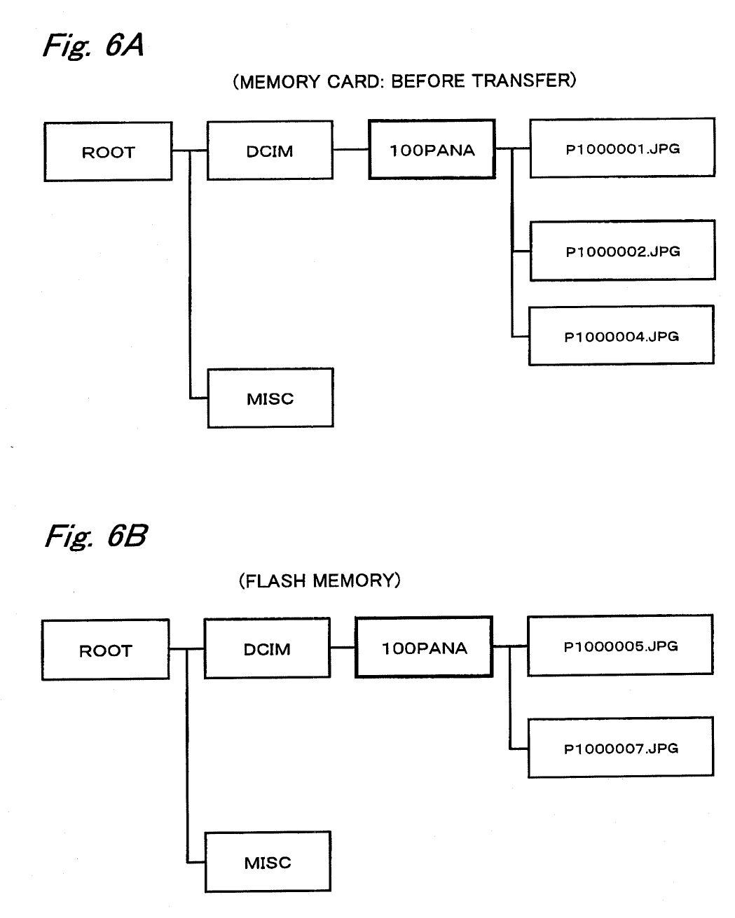

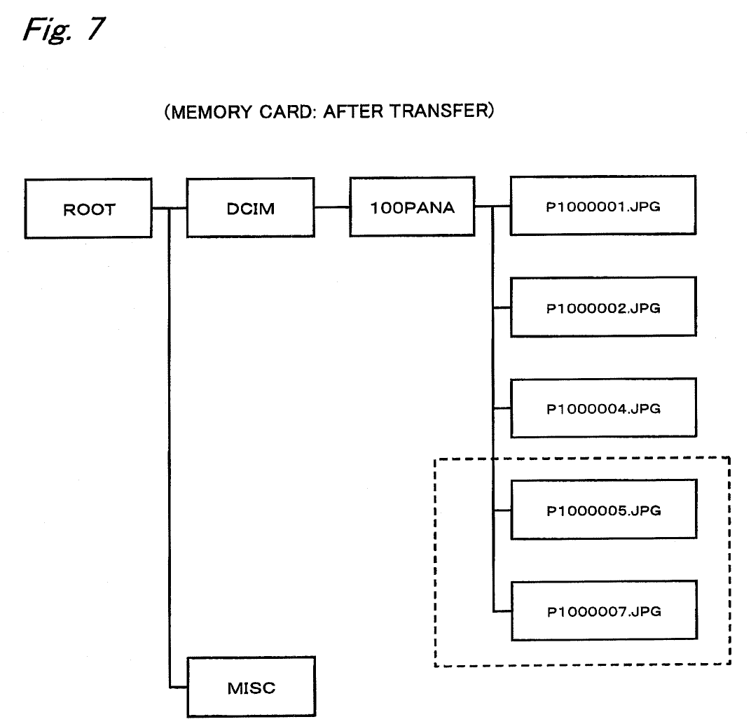

With reference to FIGS. 6A, 6B and 7, a specific example of the transfer operation from the flush memory 191 to the memory card 191 is explained below. It is assumed that a storage state of files in the memory card 191 before transfer is as shown in FIG. 6A, and the storage state of the file in the flush memory 192 is as shown in FIG. 6B. As shown in FIG. 6A and FIG. 6B, “100PANA” is the directory included commonly in both media. Namely, it is the directory having the same name. Then, it is assumed that the directory name counter 161 shows “100”, and the file name counter 162 shows “0007”.

In this case, it is assumed that the command is issued for transfer of “P1000005.JPG” and “P1000007.JPG” to the memory card 191 from the flush memory 192 (S31). At this time, the controller 160 determines that the image file having the same name is not included in the memory card 191 and the flush memory 192 (S33). Therefore, the controller 160 stores “P1000005.JPG” and “P1000007.JPG” in the directory of “100PANA” of the memory card 191 (S37). As a result, the storage state of the files in the memory card 191 becomes as shown in FIG. 7.

Thus, when no image file having the same file name is included, the image files in the directory having the same name are collected in the same directory in the memory card 191, resulting in facilitation of subsequent handling of the image files.

### 2.2.3 Example 2 of Transfer Operation

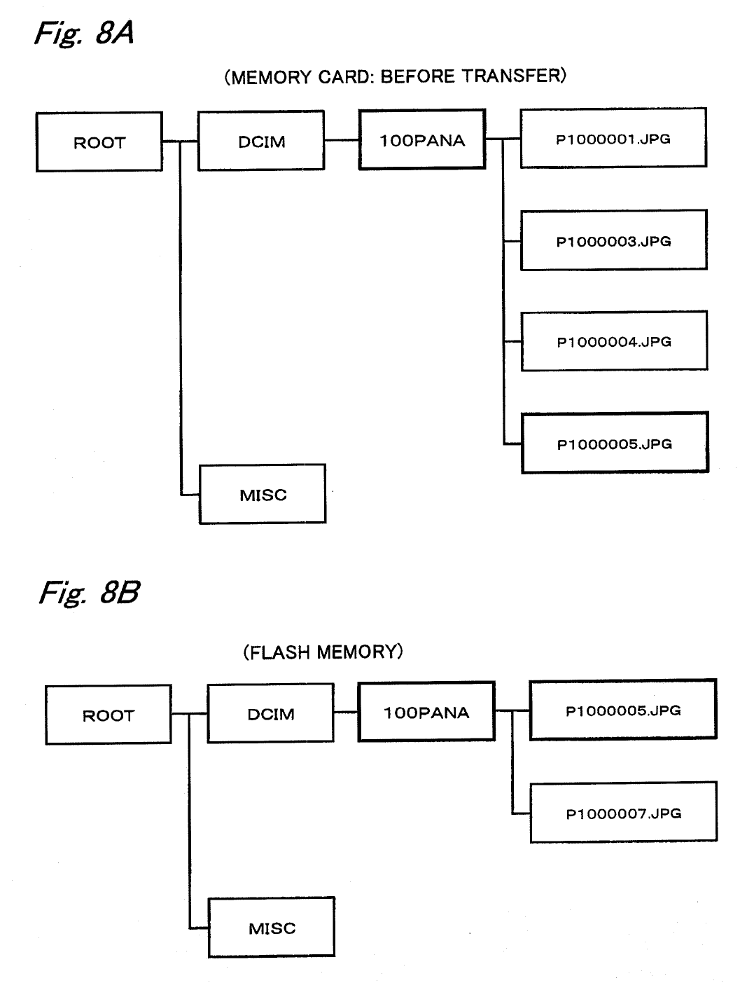

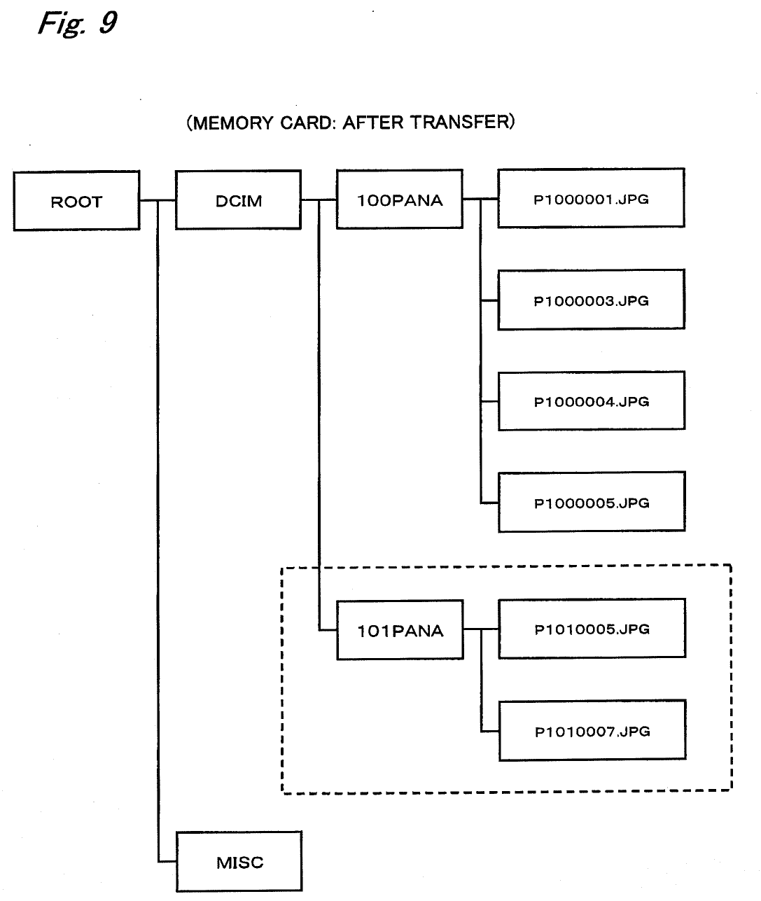

With reference to FIGS. 8A, 8B and 9, another specific example of the transfer operation to the memory card 191 from the flush memory 192 is explained below. It is assumed that the storage state of the files in the memory card 191 before transfer is as shown in FIG. 8A, and the storage state of the files in the flush memory 192 is as shown in FIG. 8B. As shown in FIGS. 8A and 8B, “100PANA” is the directory commonly included in both media. Namely, it is the directory having the same name. Then, it is assumed that the directory name counter 161 shows “100”, and the file name counter 162 shows “0007”.

Here, the files of “P1000005.JPG” are stored in both of the memory card 191 and the flush memory 192. These files have the same file name, but have possibly different contents. Thus, the same file name may possibly be provided to a different image file, in a case where the memory card 191 which stores the image files shot by a different imaging apparatus than the digital camera 100 is inserted in the digital camera 100.

Under such a circumstance, it is assumed that a command is issued for transferring “P1000005.JPG” and “P1000007.JPG” to the memory card 191 from the flush memory 192 (S31). At this time, the controller 160 determines that the memory card 191 and the flush memory 192 include the image file (“P1000005.JPG”) having the same name (S33). Therefore, the controller 160 increments the directory name counter by one, and creates a new directory “101PANA” in the memory card 191 based on the counter value (S34). The controller 160 changes the file name of the transfer source file “P1000005.JPG” and “P1000007.JPG” to “P1010005.JPG” and “P1010007.JPG” based on the directory number of the new directory (“101”), respectively (S35). Then, the controller 160 stores “P1010005.JPG” and “P1010007.JPG” in the new directory “101PANA” (S36). As a result, the storage state of the files in the memory card 191 is as shown in FIG. 9.

When the image file having the same name is included as described above, the directory is newly created, and the image file in the flush memory 192 is stored in the newly created directory. This prevents the image file having the same file name from being overwritten.

### 2.2.4 Example 3 of Transfer Operation

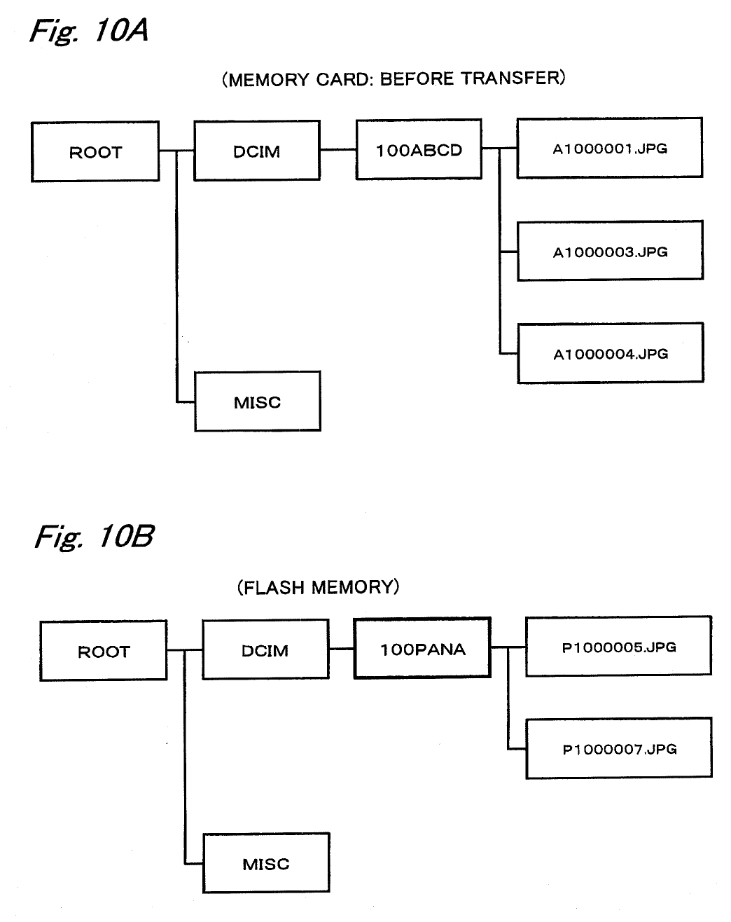

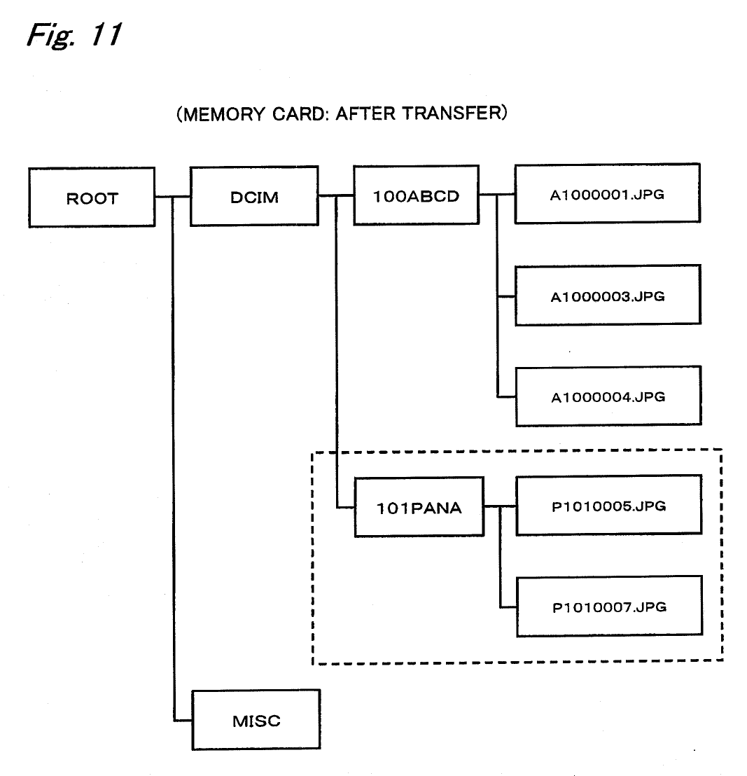

Further another specific example of the transfer operation from the flush memory 192 to the memory card 191 is explained with reference to FIGS. 10A, 10B, and 11. In this case, it is assumed that the storage state of the files in the memory card 191 is as shown in FIG. 10A, and the storage state of the files in the flush memory 192 is as shown in FIG. 10B. In addition, it is assumed that the directory name counter 161 shows “100”, and the file name counter 162 shows “0007”.

“PANA” is surely included in the directory name automatically generated by the digital camera 100 of the present embodiment. Therefore, the directory “100ABCD” shown in FIG. 10A is not the directory automatically generated by the digital camera 100 of the present embodiment. Such a directory is considered to be created by a digital camera of the other manufacturer different from the digital camera 100 of the embodiment. Namely, such a state may arise in a case where the memory card 191 which stores the image files recorded by the digital camera of the other manufacturer different from the digital camera 100 is inserted in the digital camera 100.

In this case, the controller 160 decides a new directory name based on the value (“100”) of the directory name counter 161. However, in the example of FIG. 10A, the directory number “100” is used in the existing directory name “100ABCD”. Since the overlapping directory number is not used according to the DCF standard, the value (“100”) can not be used. Therefore, the controller 160 increments the directory name counter 161 by one, and crates a new directory “101PANA” in the memory card 191 based on the counter value (S34). Based on the directory number (“101”) of the new directory, the controller 160 changes file names “P1000005.JPG” and “P1000007.JPG” to “P1010005.JPG” and “P1010007.JPG”, respectively (S35). Then, the controller 160 stores “P1010005.JPG” and “P1010007.JPG” in the new directory “101PANA” (s36). As a result, the storage state of the files in the memory card 191 is as shown in FIG. 11.

### 3. Conclusion

The digital camera 100 according to the present embodiment includes the operation unit 180 for receiving the command for transferring image files between the removable memory card 191 capable of storing the image files in one or more directories and the flush memory 192 capable of storing the image files in one or more directories, and the controller 160 for controlling the transfer.

In a case where both of the flush memory 192 and the memory card 191 have the directories having the same directory name in the recording area, when the operation unit 180 receives the transfer command, the controller 160 performs the control as follows.

Namely, when, in the image files stored in the directory of the transfer source in the flush memory 192, there is an image file having the same file name as the image file stored in the directory in the memory card 191 having the same directory name as the directory of the transfer source, a new directory is created in the storage area of the memory card 191, and the image files stored in the directory of the transfer source in the flush memory 192 are stored (transferred) in the new directory.

Meanwhile, when no one of the image files stored in the directory of the transfer source in the flush memory 192 has the same file name as the image files stored in the directory having the same directory name in the memory card 191, the image files stored in the directory of the transfer source in the flush memory 192 are stored (transferred) into the directory having the same directory name in the memory card 191.

Thus, when image file names do not overlap, such image files are collectively stored in the directory having the same directory name, while when the image file names overlap, the directory having different name is created, and the image files from the flush memory 192 is stored in this directory. Thus, when the image file names do not overlap, an unnecessary directory is not generated. Further, when the image file names overlap, the image files originally stored in the memory card 191 and the image files newly transferred can be separately managed. Therefore, it is possible to prevent the image files in the memory card 191 from being overwritten with the image files in the flush memory 192, preventing unintentionally deleting.

### 4. Variations

Variations (other embodiments) for realizing the concept of the present invention is explained hereunder.

In the above-described embodiments, the explanation is made to a case of transferring the image files to the memory card 191 from the flush memory 192. However, in the opposite case, namely, also in a case of transferring the image files to the flush memory 192 from the memory card 191, the above-described concept can be similarly applied.

In that case, when the operation unit receives the command in a case where the flush memory 192 and the memory card 191 have the directory having the same directory name, respectively, the controller 160 may operate as follows.

Specifically, when the same file name is given to any one of the image files stored in the directory with the same directory name in the flush memory 192 and any one of the image files stored in the directory with the same directory name in the memory card 191, a new directory is created in the recording area of the flush memory 192, and the image files stored in the directory with the same directory name in the memory card 191 are stored to the new directory.

Meanwhile, when no same file name is given to any one of the image files stored in the directory with the same directory name in the memory card 191 and any one of the image files stored in the directory with the same directory name in the flush memory 192, the image files stored in the directory with the same directory name in the memory card 191 are stored to the directory with the same directory name in the flush memory 192.

Further, in the aforementioned embodiment, seven character name such as “100PANA” is used as the directory name. However, the present invention is not limited to this. For example, eight character name such as “100_PANA” may also be used. Note that the DCF standard defines that the maximum number of characters of the directory name is eight.

In addition, identity of the file name can be determined by comparing the minimum file number in the directory of transfer target in the recording medium of the transfer source with the maximum file number in the directory of the same name as that of the transfer target directory in the recording medium of the transfer destination. That is, as a result of the comparison, when the minimum file number in the directory of transfer target in the recording medium of the transfer source is larger than the maximum file number in the directory of the same name in the recording medium of the transfer destination, it can be easily determined that there is no overlapped file name.

### INDUSTRIAL APPLICABILITY

The present invention can be applied to the image file management apparatus which can use a removable recording medium such as a memory card and is provided with an embedded memory. For example, the present invention can be applied to a digital still camera, a digital video camera, and a cellular phone terminal with a camera function, and so on.

What is claimed is:

1. A file management apparatus for transferring a data file stored in a first recording medium to a second recording medium, comprising:
a receiving unit operable to receive a transfer command for transferring a data file stored in a predetermined directory in the first recording medium to the second recording medium; and
a controller operable to control the transfer of the data file in accordance with the received command, wherein
when the receiving unit receives the transfer command,
if at least one of the data files stored in the predetermined directory in the first recording medium has the same file name as any one of the data files stored in the directory in the second recording medium having the same name as that of the predetermined directory,
the controller creates a new directory in the second recording medium, and stores to the new directory the data file stored in the predetermined directory of the first recording medium, and
if no one of the data files stored in the predetermined directory of the first recording medium has the same file name as those of data files stored in the directory in the second recording medium having the same name as that of the predetermined directory,
the controller stores the data file stored in the predetermined directory of the first recording medium, to the directory in the second recording medium having the same name as that of the predetermined directory.

2. The file management apparatus according to claim 1, wherein the first recording medium is a removable external recording medium, and the second recording medium is a recording medium embedded in the file management apparatus.

3. The file management device according to claim 1, wherein the first recording medium is a recording medium embedded in the file management apparatus, and the second recording medium is a removable external recording medium.

4. The file management device according to claim 1, wherein a directory name of the directory includes information regarding a sequential number assigned to the directory according to a predetermined rule.

5. The file management device according to claim 4, wherein a file name of the data file includes information regarding a sequential number assigned to the directory which stores the data file according to a predetermined rule and information regarding a sequential number assigned to the data file according to a predetermined rule.

6. The file management device according to claim 4, wherein a file name of the data file includes information regarding a sequential number assigned to the data file according to a predetermined rule.

7. The file management device according to claim 4, wherein the sequential number regarding the directory name of the new directory is assigned to follow the sequential number regarding the directory name of the predetermined directory.

8. The file management device according to claim 7, wherein when the data file is transferred from the predetermined directory in the first recording medium to the new directory in the second recording medium, the information regarding the sequential number assigned to the directory in the file name of the data file is replaced by information regarding the sequential number assigned to the new directory.

9. An imaging apparatus having an imaging element for generating an image signal from optical information of a subject, capable of recording an image file generated based on the image signal to a first recording medium or a second recording medium, comprising:
a receiving unit operable to receive a transfer command for transferring a data file stored in a predetermined directory in the first recording medium to the second recording medium; and
a controller operable to control the transfer of the data file in accordance with the received command, wherein
when the receiving unit receives the transfer command,
if at least one of the data files stored in the predetermined directory in the first recording medium has the same file name as any one of the data files stored in the directory in the second recording medium having the same name as that of the predetermined directory,
the controller creates a new directory in the second recording medium, and stores to the new directory the data file stored in the predetermined directory of the first recording medium, and
if no one of the data files stored in the predetermined directory of the first recording medium has the same file name as those of data files stored in the directory in the second recording medium having the same name as that of the predetermined directory,
the controller stores the data file stored in the predetermined directory of the first recording medium, to the directory in the second recording medium having the same name as that of the predetermined directory.

10. A file transfer method for transferring a data file stored in a first recording medium to a second recording medium, comprising:
a) determining if at least one of the data files stored in the predetermined directory in the first recording medium has the same file name as any one of the data files stored in the directory in the second recording medium having the same name as that of the predetermined directory;
b) when at least one of the data files stored in the predetermined directory in the first recording medium has the same file name as any one of the data files stored in the directory in the second recording medium having the same name as that of the predetermined directory,
creating a new directory in the second recording medium, and storing to the new directory the data file stored in the predetermined directory of the first recording medium; and
c) when no one of the data files stored in the predetermined directory of the first recording medium has the same file name as those of data files stored in the directory in the second recording medium having the same name as that of the predetermined directory,
storing the data file stored in the predetermined directory of the first recording medium, to the directory in the second recording medium having the same name as that of the predetermined directory.
